(19) United States
(12) Patent Application Publication
(10) Pub. No.: US 2018/0267211 A1
(43) Pub. Date: Sep. 20, 2018

(54) POLARIZER PROTECTIVE FILM, POLARIZING PLATE, AND IMAGE DISPLAY APPARATUS

(71) Applicant: NITTO DENKO CORPORATION, Osaka (JP)

(72) Inventors: Nobuyuki Haida, Ibaraki-shi (JP); Shintaro Azuma, Ibaraki-shi (JP); Masayuki Okamoto, Ibaraki-shi (JP); Tetsuro Ikeda, Ibaraki-shi (JP); Daigoro Nakagawa, Ibaraki-shi (JP)

(73) Assignee: NITTO DENKO CORPORATION, Osaka (JP)

(21) Appl. No.: 15/918,279

(22) Filed: Mar. 12, 2018

(30) Foreign Application Priority Data
Mar. 15, 2017 (JP) 2017-050387

(51) Int. Cl. G02B 1/14; C08J 5/18; C08L 33/12

(52) U.S. Cl. CPC G02B 1/14; G02B 5/3025; C08L 33/12; C08J 5/18

(57) ABSTRACT

There is provided a polarizer protective film excellent in both bending resistance and adhesiveness with a polarizer. A polarizer protective film according to an embodiment of the present invention includes: an acrylic resin; and reinforcing particles dispersed in the acrylic resin. The reinforcing particles have flat shapes, and have a length-to-thickness ratio of 7.0 or less.

### BACKGROUND OF THE INVENTION

This application claims priority under 35 U.S.C. Section 119 to Japanese Patent Application No. 2017-050387 filed on Mar. 15, 2017 which is herein incorporated by reference.

### 1. Field of the Invention

The present invention relates to a polarizer protective film, a polarizing plate, and an image display apparatus.

### 2. Description of the Related Art

In many cases, a polarizing plate is arranged on at least one side of a display cell of an image display apparatus (e.g., a liquid crystal display apparatus or an organic EL display apparatus) because of its image-forming system. In recent years, the thinning and flexibilization of the image display apparatus have been advancing, and the thinning of the polarizing plate and films forming the polarizing plate (e.g., a polarizer protective film) have also been strongly demanded along with the advance. When an attempt is made to thin the polarizing plate and the films forming the polarizing plate, it may be difficult to convey the respective films in a polarizing plate-producing process, and as a result, a reduction in yield due to a conveyance failure and/or rupture may occur. A technology involving adding rubber particles to the polarizer protective film has been proposed for solving such problem (e.g., Japanese Patent Application Laid-open No. 2015-210474). However, such polarizer protective film involves a problem in that its adhesiveness with a polarizer is insufficient and hence its peeling occurs. Further, when the polarizing plate is applied to a flexible image display apparatus, a polarizing plate excellent in bending resistance and a polarizer protective film that can achieve such polarizing plate have been demanded.

### SUMMARY OF THE INVENTION

The present invention has been made to solve the above-mentioned problems, and a primary object of the present invention is to provide a polarizer protective film excellent in both bending resistance and adhesiveness with a polarizer.

A polarizer protective film according to an embodiment of the present invention includes: an acrylic resin; and reinforcing particles dispersed in the acrylic resin. The reinforcing particles have flat shapes, and have a length-to-thickness ratio of 7.0 or less.

In one embodiment of the present invention, the acrylic resin has at least one selected from the group consisting of a glutarimide unit, a lactone ring unit, a maleic anhydride unit, a maleimide unit, and a glutaric anhydride unit.

In another embodiment of the present invention, a content of the reinforcing particles is from 7 wt % to 30 wt %.

In still another embodiment of the present invention, the length-to-thickness ratio of the reinforcing particles is 2.0 or more.

In still another embodiment of the present invention, the reinforcing particles each have a core famed of a rubber-like polymer and a covering layer formed of a glass-like polymer, the covering layer being configured to cover the core.

Instill another embodiment of the present invention, the core has a thickness of from 20 nm to 100 nm, and the core has a characteristic length of from 200 nm to 600 nm.

In still another embodiment of the present invention, the polarizer protective film includes a biaxially stretched film.

In still another embodiment of the present invention, the polarizer protective film has an in-plane retardation Re(550) of from 0 nm to 10 nm, and has a thickness direction retardation Rth(550) of from −20 nm to +10 nm.

According to another aspect of the present invention, there is provided a polarizing plate. The polarizing plate includes: a polarizer; and the above-described polarizer protective film arranged on at least one side of the polarizer.

According to another aspect of the present invention, there is provided an image display apparatus. The image display apparatus includes the polarizing plate as described above.

According to the present invention, the polarizer protective film excellent in both bending resistance and adhesiveness with a polarizer can be obtained by using a predetermined acrylic resin and flat-shaped reinforcing particles having an optimized length-to-thickness ratio in combination.

### DESCRIPTION OF THE EMBODIMENTS

A polarizer protective film according to an embodiment of the present invention includes an acrylic resin and reinforcing particles dispersed in the acrylic resin. The constituent components of the polarizer protective film are specifically described below.

### A. Acrylic Resin

### A-1. Constitution of Acrylic Resin

Any appropriate acrylic resin may be adopted as the acrylic resin. The acrylic resin typically contains an alkyl (meth)acrylate, which serves as a monomer unit, as a main component. The term “(meth)acryl” as used herein means an acryl and/or a methacryl. Examples of the alkyl (meth)acrylate forming the main skeleton of the acrylic resin may include (meth)acrylates each having a linear or branched alkyl group having 1 to 18 carbon atoms. Those (meth)acrylates may be used alone or in combination thereof. Further, any appropriate copolymerizable monomer may be introduced into the acrylic resin by copolymerization. The kinds, number, copolymerization ratios, and the like of such copolymerizable monomers may be appropriately set in accordance with purposes. The constituent component (monomer unit) for the main skeleton of the acrylic resin is described later with reference to the general formula (2).

The acrylic resin preferably has at least one selected from the group consisting of a glutarimide unit, a lactone ring unit, a maleic anhydride unit, a maleimide unit, and a glutaric anhydride unit. The acrylic resin having a lactone ring unit is described in, for example, Japanese Patent Application Laid-open No. 2008-181078, and the description of the publication is incorporated herein by reference. The glutarimide unit is preferably represented by the following general formula (1).

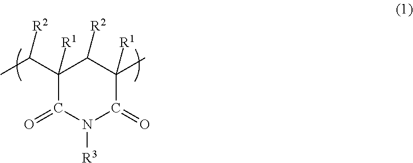

In the general formula (1), R¹ and R² each independently represent a hydrogen atom or an alkyl group having 1 to 8 carbon atoms, and R³ represents a hydrogen atom, an alkyl group having 1 to 18 carbon atoms, a cycloalkyl group having 3 to 12 carbon atoms, or an aryl group having 6 to 10 carbon atoms. In the general formula (1), it is preferred that R¹ and R² each independently represent a hydrogen atom or a methyl group, and R³ represent a hydrogen atom, a methyl group, a butyl group, or a cyclohexyl group, and it is more preferred that R² represent a methyl group, R² represent a hydrogen atom, and R³ represent a methyl group.

The alkyl (meth)acrylate is typically represented by the following general formula (2).

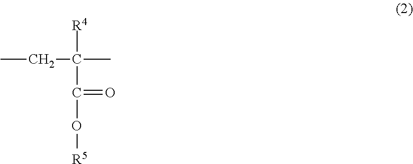

In the general formula (2), R⁴ represents a hydrogen atom or a methyl group, and R⁵ represents a hydrogen atom, or an aliphatic or alicyclic hydrocarbon group having 1 to 6 carbon atoms that may be substituted. As a substituent thereof, there are given, for example, a halogen atom and a hydroxy group. Specific examples of the alkyl (meth)acrylate include methyl (meth)acrylate, ethyl (meth)acrylate, n-propyl (meth)acrylate, n-butyl (meth)acrylate, t-butyl (meth)acrylate, n-hexyl (meth)acrylate, cyclohexyl (meth)acrylate, chloromethyl (meth)acrylate, 2-chloroethyl (meth)acrylate, 2-hydroxyethyl (meth)acrylate, 3-hydroxypropyl (meth)acrylate, 2,3,4,5,6-pentahydroxyhexyl (meth)acrylate, and 2,3,4,5-tetrahydroxypentyl (meth)acrylate. In the general formula (2), it is preferred that R⁵ represent a hydrogen atom or a methyl group. Therefore, the alkyl (meth)acrylate is particularly preferably methyl acrylate or methyl methacrylate.

The acrylic resin may contain only a single glutarimide unit, or may contain a plurality of glutarimide units different from each other in R¹, R², and R³ in the general formula (1).

The content of the glutarimide unit in the acrylic resin is preferably from 2 mol % to 50 mol %, more preferably from 2 mol % to 45 mol %, still more preferably from 2 mol % to 40 mol %, particularly preferably from 2 mol % to 35 mol %, most preferably from 3 mol % to 30 mol %. When the content is less than 2 mol %, effects to be expressed as a result of the presence of the glutarimide unit (e.g., high optical characteristics, a high mechanical strength, an excellent adhesive property with a polarizer, and thinning) may not be sufficiently exhibited. When the content is more than 50 mol %, for example, the heat resistance and transparency of the resin may be insufficient.

The acrylic resin may contain only a single alkyl (meth)acrylate unit, or may contain a plurality of alkyl (meth)acrylate units different from each other in R⁴ and R⁵ in the general formula (2).

The content of the alkyl (meth)acrylate unit in the acrylic resin is preferably from 50 mol % to 98 mol %, more preferably from 55 mol % to 98 mol %, still more preferably from 60 mol % to 98 mol %, particularly preferably from 65 mol % to 98 mol %, most preferably from 70 mol % to 97 mol %. When the content is less than 50 mol %, effects to be expressed as a result of the presence of the alkyl (meth)acrylate unit (e.g., high heat resistance and high transparency) may not be sufficiently exhibited. When the content is more than 98 mol %, the following risk occurs: the resin becomes brittle and easy to break, and hence cannot sufficiently exhibit a high mechanical strength, thereby leading to poor productivity.

The acrylic resin may contain a unit other than the glutarimide unit and the alkyl (meth)acrylate unit.

In one embodiment, the acrylic resin may contain an unsaturated carboxylic acid unit that is not involved in an intramolecular imidization reaction to be described later at, for example, from 0 wt % to 10 wt %. The content of the unsaturated carboxylic acid unit is preferably from 0 wt % to 5 wt %, more preferably from 0 wt % to 1 wt %. When the content falls within such range, the transparency, retention stability, and moisture resistance of the resin can be maintained.

In one embodiment, the acrylic resin may contain a copolymerizable vinyl-based monomer unit other than those described above (other vinyl-based monomer unit). Examples of the other vinyl-based monomer include acrylonitrile, methacrylonitrile, ethacrylonitrile, allyl glycidyl ether, maleic anhydride, itaconic anhydride, N-methylmaleimide, N-ethylmaleimide, N-cyclohexylmaleimide, aminoethyl acrylate, propylaminoethyl acrylate, dimethylaminoethyl methacrylate, ethylaminopropyl methacrylate, cyclohexylaminoethyl methacrylate, N-vinyldiethylamine, N-acetylvinylamine, allylamine, methallylamine, N-methylallylamine, 2-isopropenyl-oxazoline, 2-vinyl-oxazoline, 2-acryloyl-oxazoline, N-phenylmaleimide, phenylaminoethyl methacrylate, styrene, α-methylstyrene, p-glycidylstyrene, p-aminostyrene, and 2-styryl-oxazoline. Those monomers may be used alone or in combination thereof. Of those, a styrene-based monomer, such as styrene or α-methylstyrene, is preferred. The content of the other vinyl-based monomer unit is preferably from 0 wt % to 1 wt %, more preferably from 0 wt % to 0.1 wt %. When the content falls within such range, the expression of an undesired retardation and a reduction in transparency of the resin can be suppressed.

An imidization ratio in the acrylic resin is preferably from 2.5% to 20.0%. When the imidization ratio falls within such range, a resin excellent in heat resistance, transparency, and forming processability is obtained, and the occurrence of burning and a reduction in mechanical strength at the time of the forming of the film can be prevented. In the acrylic resin, the imidization ratio is represented by a ratio between the glutarimide unit and the alkyl (meth)acrylate unit. The ratio may be obtained from, for example, the NMR spectrum or IR spectrum of the acrylic resin. In this embodiment, the imidization ratio may be determined by the ¹H-NMR measurement of the resin using ¹H-NMR BRUKER AvanceIII (400 MHz). More specifically, the ratio is determined from the below-indicated equation where A represents the area of a peak derived from an O—CH₃ proton of the alkyl (meth)acrylate around from 3.5 ppm to 3.8 ppm, and B represents the area of a peak derived from a N—CH₃ proton of glutarimide around from 3.0 ppm to 3.3 ppm.

Imidization ratio Im (%)={B/(A+B)}×100

The acid value of the acrylic resin is preferably from 0.10 mmol/g to 0.50 mmol/g. When the acid value falls within such range, a resin excellent in balance among its heat resistance, mechanical properties, and forming processability can be obtained. When the acid value is excessively small, a problem, such as an increase in cost due to the use of a modifying agent for adjusting the acid value to a desired value or the occurrence of a gel-like product due to the remaining of the modifying agent, may occur. When the acid value is excessively large, forming is liable to occur at the time of the forming of the film (e.g., at the time of melt extrusion), and hence the productivity of a famed article tends to reduce. In the acrylic resin, the acid value is the content of a carboxylic acid unit and a carboxylic anhydride unit in the acrylic resin. In this embodiment, the acid value may be calculated by a titration method described in, for example, WO 2005/054311 A1 or Japanese Patent Application Laid-open No. 2005-23272.

The acrylic resin has a weight-average molecular weight of preferably from 1,000 to 2,000,000, more preferably from 5,000 to 1,000,000, still more preferably from 10,000 to 500,000, particularly preferably from 50,000 to 500,000, most preferably from 60,000 to 150,000. The weight-average molecular weight may be determined with, for example, a gel permeation chromatograph (GPC SYSTEM, manufactured by Tosoh Corporation) through polystyrene conversion. Tetrahydrofuran may be used as a solvent.

The glass transition temperature (Tg) of the acrylic resin is preferably 110° C. or more, more preferably 115° C. or more, still more preferably 120° C. or more, particularly preferably 125° C. or more, most preferably 130° C. or more. When the Tg is 110° C. or more, a polarizing plate including the polarizer protective film obtained from such resin tends to be excellent in durability. An upper limit value for the Tg is preferably 300° C. or less, more preferably 290° C. or less, still more preferably 285° C. or less, particularly preferably 200° C. or less, most preferably 160° C. or less. When the Tg falls within such range, the resin can be excellent in forming properties.

### A-2. Polymerization of Acrylic Resin

The acrylic resin may be produced by, for example, the following method. The method involves: (I) copolymerizing an alkyl (meth)acrylate monomer corresponding to the alkyl (meth)acrylate unit represented by the general formula (2), and an unsaturated carboxylic acid monomer and/or a precursor monomer thereof to provide a copolymer (a); and (II) treating the copolymer (a) with an imidizing agent to perform an intramolecular imidization reaction between the alkyl (meth)acrylate monomer unit, and the unsaturated carboxylic acid monomer and/or the precursor monomer unit thereof in the copolymer (a) to introduce the glutarimide unit represented by the general formula (1) into the copolymer.

Examples of the unsaturated carboxylic acid monomer include acrylic acid, methacrylic acid, crotonic acid, α-substituted acrylic acids, and α-substituted methacrylic acids. Examples of the precursor monomer thereof include acrylamide and methacrylamide. The monomers may be used alone or in combination thereof. The unsaturated carboxylic acid monomer is preferably acrylic acid or methacrylic acid, and the precursor monomer is preferably acrylamide.

Any appropriate method may be used as a method of treating the copolymer (a) with the imidizing agent. Specific examples thereof include a method involving using an extruder and a method involving using a batch-type reaction tank (pressure vessel). The method involving using the extruder involves heating and melting the copolymer (a) with the extruder, and treating the copolymer with the imidizing agent. In this case, any appropriate extruder may be used as the extruder. Specific examples thereof include a uniaxial extruder, a biaxial extruder, and a multiaxial extruder. In the method involving using the batch-type reaction tank (pressure vessel), any appropriate batch-type reaction tank (pressure vessel) may be used.

Any appropriate compound may be used as the imidizing agent as long as the glutarimide unit represented by the general formula (1) can be produced. Specific examples of the imidizing agent include: aliphatic hydrocarbon group-containing amines, such as methylamine, ethylamine, n-propylamine, i-propylamine, n-butylamine, i-butylamine, tert-butylamine, and n-hexylamine; aromatic hydrocarbon group-containing amines, such as aniline, benzylamine, toluidine, and trichloroaniline; and alicyclic hydrocarbon group-containing amines, such as cyclohexylamine. Further, for example, a urea-based compound that generates such amine by heating may also be used. Examples of the urea-based compound include urea, 1,3-dimethylurea, 1,3-diethylurea, and 1,3-dipropylurea. The imidizing agent is preferably methylamine, ammonia, or cyclohexylamine, more preferably methylamine.

In the imidization, as required, a ring-closing accelerator may be added in addition to the imidizing agent.

The usage amount of the imidizing agent in the imidization is preferably from 0.5 part by weight to 10 parts by weight, more preferably from 0.5 part by weight to 6 parts by weight with respect to 100 parts by weight of the copolymer (a). When the usage amount of the imidizing agent is less than 0.5 part by weight, a desired imidization ratio is not achieved in many cases. As a result, the heat resistance of the resin to be obtained becomes extremely insufficient, and hence an external appearance defect, such as burning, after the forming of the film is induced in some cases. When the usage amount of the imidizing agent is more than 10 parts by weight, the imidizing agent remains in the resin, and hence an external appearance defect, such as burning, and forming after the forming are induced by the imidizing agent in some cases.

The production method of this embodiment may include treatment with an esterifying agent as required in addition to the imidization.

Examples of the esterifying agent include dimethyl carbonate, 2,2-dimethoxypropane, dimethyl sulfoxide, triethyl orthoformate, trimethyl orthoacetate, trimethyl orthoformate, diphenyl carbonate, dimethyl sulfate, methyl toluenesulfonate, methyl trifluoromethanesulfonate, methyl acetate, methanol, ethanol, methyl isocyanate, p-chlorophenyl isocyanate, dimethylcarbodiimide, dimethyl-t-butylsilyl chloride, isopropenyl acetate, dimethylurea, tetramethylammonium hydroxide, dimethyl diethoxysilane, tetra-N-butoxysilane, dimethyl(trimethylsilane) phosphite, trimethyl phosphite, trimethyl phosphate, tricresyl phosphate, diazomethane, ethylene oxide, propylene oxide, cyclohexene oxide, 2-ethylhexyl glycidyl ether, phenyl glycidyl ether, and benzyl glycidyl ether. Of those, dimethyl carbonate is preferred from the viewpoints of cost, reactivity, and the like.

The addition amount of the esterifying agent may be set so that the acid value of the acrylic resin may be a desired value.

### A-3. Combined Use of Other Resin

In the embodiment of the present invention, the acrylic resin and any other resin may be used in combination. That is, any one of the following procedures may be adopted: a monomer component forming the acrylic resin and a monomer component forming the other resin are copolymerized to provide a copolymer, and the copolymer is subjected to film formation to be described later in the section C; or a blend of the acrylic resin and the other resin is subjected to the film formation. Examples of the other resin include: other thermoplastic resins, such as a styrene-based resin, polyethylene, polypropylene, polyamide, polyphenylene sulfide, polyether ether ketone, polyester, polysulfone, polyphenylene oxide, polyacetal, polyimide, and polyether imide; and thermosetting resins, such as a phenol-based resin, a melamine-based resin, a polyester-based resin, a silicone-based resin, and an epoxy-based resin. The kind and compounding amount of the resin to be used in combination may be appropriately set in accordance with, for example, purposes and characteristics that the film to be obtained is desired to have. For example, a styrene-based resin (preferably an acrylonitrile-styrene copolymer) may be used in combination as a retardation-controlling agent.

When the acrylic resin and the other resin are used in combination, the content of the acrylic resin in the blend of the acrylic resin and the other resin is preferably from 50 wt % to 100 wt %, more preferably from 60 wt % to 100 wt %, still more preferably from 70 wt % to 100 wt %, particularly preferably from 80 wt % to 100 wt %. When the content is less than 50 wt %, it may be impossible to sufficiently reflect high heat resistance and high transparency intrinsic to the acrylic resin.

### B. Reinforcing Particles

As described above, the reinforcing particles have flat shapes. Further, the length-to-thickness ratio of the reinforcing particles is 7.0 or less. The length-to-thickness ratio is preferably 6.5 or less, more preferably 6.3 or less. Meanwhile, the length-to-thickness ratio is preferably 2.0 or more, more preferably 3.5 or more, still more preferably 4.5 or more, particularly preferably 5.0 or more. When the length-to-thickness ratio falls within such range, adhesiveness between the polarizer protective film and a polarizer can be significantly improved while excellent bending resistance resulting from the compounding of the particles is maintained. The term “length-to-thickness ratio” as used herein means the ratio of a characteristic length in the plan-view shape of a reinforcing particle to a thickness of the reinforcing particle. The term “characteristic length” as used herein refers to a diameter when the plan-view shape is a circular shape, refers to a long diameter when the plan-view shape is an elliptical shape, and refers to the length of a diagonal when the plan-view shape is a rectangular shape or a polyhedral shape. The ratio may be determined by, for example, the following procedure. An obtained film section is photographed with a transmission electron microscope (e.g., an acceleration voltage of 80 kV, a RuO₄ staining ultrathin sectioning method), and the 30 longest particles (particles in which sections close to their characteristic lengths are obtained) are sampled from the reinforcing particles present in the resultant photograph, followed by the calculation of the ratio of the average of the lengths of the particles to the average of the thicknesses thereof. Thus, the ratio may be obtained.

The reinforcing particles each typically have a core formed of a rubber-like polymer and a covering layer famed of a glass-like polymer, the covering layer being configured to cover the core. In other words, the reinforcing particles may be obtained by flattening so-called core-shell-type particles. The reinforcing particles may each have one or more layers each famed of a glass-like polymer as innermost layers or intermediate layers. However, in the embodiment of the present invention, in a process for the dispersion of the core-shell-type particles in the resin component of the film, each of the covering layers is compatible with the resin component, and hence the covering layer cannot be recognized visually (including a case in which the layer is observed through a microscope or the like) in some cases.

The Tg of the rubber-like polymer forming the core is preferably 20° C. or less, more preferably from −60° C. to 20° C., still more preferably from −60° C. to 10° C. When the Tg of the rubber-like polymer forming the core is more than 20° C., an improvement in mechanical strength of the acrylic resin may not be sufficient. The Tg of the glass-like polymer (rigid polymer) forming the covering layer is preferably 50° C. or more, more preferably from 50° C. to 140° C., still more preferably from 60° C. to 130° C. When the Tg of the glass-like polymer forming the covering layer is less than 50° C., the heat resistance of the acrylic resin may reduce.

The content of the core in each of the reinforcing particles is preferably from 30 wt % to 95 wt %, more preferably from 50 wt % to 90 wt %. The ratio of a glass-like polymer layer in the core is from 0 wt % to 60 wt %, preferably from 0 wt % to 45 wt %, more preferably from 10 wt % to 40 wt % with respect to 100 wt % of the total weight of the core. The content of the covering layer in each of the reinforcing particles is preferably from 5 wt % to 70 wt %, more preferably from 10 wt % to 50 wt %.

The thickness of the core is preferably from 20 nm to 100 nm. The characteristic length of the core is preferably from 200 nm to 600 nm. When the characteristic length of the core is excessively short, an improvement in mechanical strength of the film to be obtained may be insufficient. When the thickness of the core is excessively large or when the characteristic length of the core is excessively long, adhesiveness between the film to be obtained and a polarizer may be impaired.

The reinforcing particles are incorporated at preferably from 7 wt % to 30 wt %, more preferably from 8 wt % to 25 wt % into the polarizer protective film. When the content of the reinforcing particles falls within such range, extremely excellent adhesiveness with a polarizer and extremely excellent bending resistance can be achieved.

Details about the rubber-like polymer forming the core of each of the reinforcing particles, the glass-like polymer (rigid polymer) forming the covering layer of each of the particles, methods of polymerizing the polymers, and other constitutions are described in, for example, Japanese Patent Application Laid-open No. 2016-33552 regarding the core-shell-type particles. The description of the publication is incorporated herein by reference.

The formation of the reinforcing particles (flattening of the core-shell-type particles) is described later in the section C in relation to the formation of the polarizer protective film.

### C. Formation of Polarizer Protective Film

The polarizer protective film according to the embodiment of the present invention may be typically formed by a method involving: forming a composition containing the acrylic resin (when any other resin is used in combination, a blend with the other resin) and the core-shell-type particles into a film; and stretching the resultant film.

The core-shell-type particles are precursors of the reinforcing particles described in the section B, and are spherical particles each having a core and a covering layer. The average particle diameter of the cores is preferably from 70 nm to 300 nm.

Any appropriate method may be adopted as a method of forming the film. Specific examples thereof include a cast coating method (e.g., a casting method), an extrusion molding method, an injection molding method, a compression molding method, a transfer molding method, a blow molding method, a powder molding method, a FRP molding method, a calender method, and a hot pressing method. Of those, an extrusion molding method or a cast coating method is preferred. This is because the smoothness of the film to be obtained is improved and hence satisfactory optical uniformity can be obtained. Of those, an extrusion molding method is particularly preferred. This is because there is no need to consider a problem caused by a remaining solvent. Of such extrusion molding methods, an extrusion molding method involving using a T-die is preferred from the viewpoints of the productivity of the film and the ease of the subsequent stretching treatment. Forming conditions may be appropriately set in accordance with, for example, the composition and kind of a resin to be used, and characteristics that the film to be obtained is desired to have.

Any appropriate stretching method and stretching conditions (e.g., a stretching temperature, a stretching ratio, a stretching speed, and a stretching direction) may be adopted as a stretching method. Specific examples of the stretching method include free-end stretching, fixed-end stretching, free-end shrinkage, and fixed-end shrinkage. Those methods may be used alone, may be simultaneously used, or may be sequentially used.

Any appropriate direction may be adopted as the stretching direction in accordance with purposes. Specific examples thereof include a lengthwise direction, a widthwise direction, a thickness direction, and an oblique direction. The number of the stretching directions may be one (uniaxial stretching), may be two (biaxial stretching), or may be three or more. In the embodiment of the present invention, the uniaxial stretching in the lengthwise direction, simultaneous biaxial stretching in the lengthwise direction and the widthwise direction, or sequential biaxial stretching in the lengthwise direction and the widthwise direction may be typically adopted. Of those, biaxial stretching (simultaneous or sequential) is preferred. This is because the in-plane retardation of the film is easily controlled and hence optical isotropy is easily achieved.

When the biaxial stretching is adopted, a stretching mode may be simultaneous biaxial stretching, or may be sequential biaxial stretching. The simultaneous biaxial stretching is superior to the sequential stretching in view of film external appearance because the simultaneous biaxial stretching is free of any roll stretching step and hence the surface of the film is hardly flawed. In contrast, the sequential biaxial stretching is superior to the simultaneous biaxial stretching in view of productivity because a longitudinal stretching step and a lateral stretching step are separate from each other in the sequential biaxial stretching, and hence the film hardly ruptures. In the sequential biaxial stretching, any one of the longitudinal stretching and the lateral stretching may be performed prior to the other. In the sequential biaxial stretching, the longitudinal stretching and the lateral stretching are preferably performed in the stated order.

The stretching temperature may change in accordance with, for example, optical characteristics, mechanical characteristics, and a thickness that the polarizer protective film is desired to have, the kind of a resin to be used, the thickness of the film to be used, the stretching method (the uniaxial stretching or the biaxial stretching), the stretching ratio, and the stretching speed. Specifically, the stretching temperature is preferably from Tg to Tg+60° C., more preferably from Tg+15° C. to Tg+60° C., most preferably from Tg+30° C. to Tg+60° C. When the stretching is performed at such temperature, a polarizer protective film having appropriate characteristics can be obtained. A specific stretching temperature is, for example, from 150° C. to 175° C., preferably from 155° C. to 175° C. When the stretching temperature falls within such range, a polarizer protective film excellent in both bending resistance and adhesiveness with a polarizer can be obtained by appropriately adjusting the stretching ratio and the stretching speed. The team “Tg” as used in this context refers to the Tg of the resin component of the composition.

As in the stretching temperature, the stretching ratio may also change in accordance with, for example, the optical characteristics, the mechanical characteristics, and the thickness that the polarizer protective film is desired to have, the kind of the resin to be used, the thickness of the film to be used, the stretching method (the uniaxial stretching or the biaxial stretching), the stretching temperature, and the stretching speed. A ratio between a stretching ratio in one direction and a stretching ratio in the other direction is preferably from 1.0 to 1.5, more preferably from 1.0 to 1.4, still more preferably from 1.0 to 1.3. In one embodiment, the one direction and the other direction are perpendicular to each other. For example, one of the two directions may be the lengthwise direction (MD: Machine Direction), and the other thereof may be the widthwise direction (TD: Transverse Direction). A total stretching ratio (product of a stretching ratio in one direction and a stretching ratio in the other direction) when the biaxial stretching is adopted is preferably from 2.0 to 6.0, more preferably from 3.0 to 5.5, still more preferably from 3.5 to 5.2. When the total stretching ratio falls within such range, a polarizer protective film excellent in both bending resistance and adhesiveness with a polarizer can be obtained by appropriately adjusting the stretching temperature and the stretching speed.

As in the stretching temperature, the stretching speed may also change in accordance with, for example, the optical characteristics, the mechanical characteristics, and the thickness that the polarizer protective film is desired to have, the kind of the resin to be used, the thickness of the film to be used, the stretching method (the uniaxial stretching or the biaxial stretching), the stretching temperature, and the stretching ratio. The stretching speed is preferably from 3%/sec to 20%/sec, more preferably from 3%/sec to 15%/sec, still more preferably from 3%/sec to 10%/sec. When the biaxial stretching is adopted, a stretching speed in one direction and a stretching speed in the other direction may be equal to or different from each other. For example, a ratio between the stretching speed in the one direction and the stretching speed in the other direction is preferably from 1.0 to 1.3, more preferably from 1.0 to 1.2, still more preferably from 1.0 to 1.1. When the stretching speed falls within such range, a polarizer protective film excellent in both bending resistance and adhesiveness with a polarizer can be obtained by appropriately adjusting the stretching temperature and the stretching ratio.

The core-shell-type particles are appropriately flattened by such stretching as described above, and hence such reinforcing particles having desired structures and characteristics as described in the section B can be famed. In more detail, it is assumed that the cores of the core-shell-type particles are appropriately flattened by performing the stretching at such stretching temperature and stretching speed as described above. It has been confirmed that the cores have Tg's lower than those of their surroundings, and are flattened to a larger extent by low-temperature stretching, high-ratio stretching, and/or high-stretching-speed stretching, and hence the length-to-thickness ratio of the reinforcing particles increases. It has been considered that the increase significantly improves the bending resistance of the polarizer protective film. Meanwhile, when the length-to-thickness ratio is excessively large (e.g., more than 7.0), the adhesiveness of the polarizer protective film with a polarizer may reduce. It is assumed that both the bending resistance and the adhesiveness are achieved by optimizing the length-to-thickness ratio.

Thus, the polarizer protective film can be formed.

### D. Polarizer Protective Film and its Characteristics

It is preferred that the polarizer protective film substantially have optical isotropy. The phrase “substantially have optical isotropy” as used herein means that the film has an in-plane retardation Re(550) of from 0 nm to 10 nm, and a thickness direction retardation Rth(550) of from −20 nm to +10 nm. The in-plane retardation Re(550) is more preferably from 0 nm to 5 nm, still more preferably from 0 nm to 3 nm, particularly preferably from 0 nm to 2 nm. The thickness direction retardation Rth(550) is more preferably from −5 nm to +5 nm, still more preferably from −3 nm to +3 nm, particularly preferably from −2 nm to +2 nm. When the Re(550) and Rth(550) of the polarizer protective film fall within such ranges, adverse effects on display characteristics in the case where a polarizing plate including the polarizer protective film is applied to an image display apparatus can be prevented. The Re(550) is the in-plane retardation of the film measured with light having a wavelength of 550 nm at 23° C. The Re(550) is determined from an equation “Re(550)=(nx−ny)×d”. The Rth(550) is the thickness direction retardation of the film measured with light having a wavelength of 550 nm at 23° C. The Rth(550) is determined from an equation “Rth(550)=(nx−nz)×d”. Here, nx represents a refractive index in a direction in which an in-plane refractive index is maximum (i.e., a slow axis direction), ny represents a refractive index in a direction perpendicular to the slow axis in the plane (i.e., a fast axis direction), nz represents a refractive index in a thickness direction, and d represents the thickness (nm) of the film.

The transmittance of the polarizer protective film for light having a wavelength of 380 nm at a thickness of 80 μm is preferably as high as possible. Specifically, the light transmittance is preferably 85% or more, more preferably 88% or more, still more preferably 90% or more. When the light transmittance falls within such range, desired transparency can be secured. Not only excellent bending resistance and excellent adhesiveness with a polarizer but also such light transmittance can be achieved by optimizing the length-to-thickness ratio of the reinforcing particles like the above-mentioned range. The light transmittance may be measured by, for example, a method in conformity with ASTM-D-1003.

The haze of the polarizer protective film is preferably as low as possible. Specifically, the haze is preferably 5% or less, more preferably 3% or less, still more preferably 1.5% or less, particularly preferably 1% or less. When the haze is 5% or less, a satisfactory clear feeling can be imparted to the film. Further, even when the film is used in the viewer-side polarizing plate of an image display apparatus, display contents can be satisfactorily viewed. Not only excellent bending resistance and excellent adhesiveness with a polarizer but also such haze can be achieved by optimizing the length-to-thickness ratio of the reinforcing particles like the above-mentioned range.

The YI of the polarizer protective film at a thickness of 80 μm is preferably 1.27 or less, more preferably 1.25 or less, still more preferably 1.23 or less, particularly preferably 1.20 or less. When the YI is more than 1.3, the optical transparency of the film may be insufficient. Not only excellent bending resistance and excellent adhesiveness with a polarizer but also such YI can be achieved by optimizing the length-to-thickness ratio of the reinforcing particles like the above-mentioned range. The YI may be determined from the below-indicated equation by using the tristimulus values (X, Y, and Z) of a color obtained by measurement with, for example, a high-speed integrating-sphere spectral transmittance-measuring machine (product name: DOT-3C: manufactured by Murakami Color Research Laboratory Co., Ltd.).

YI=[(1.28X−1.06Z)/Y]×100

The b value (measure of a hue in conformity with Hunter's color system) of the polarizer protective film at a thickness of 80 μm is preferably less than 1.5, more preferably 1.0 or less. When the b value is 1.5 or more, an undesired tinge may appear. The b value may be obtained by, for example, cutting the polarizer protective film sample into a 3-centimeter square, measuring its hue with a high-speed integrating-sphere spectral transmittance-measuring machine (product name: DOT-3C: manufactured by Murakami Color Research Laboratory Co., Ltd.), and evaluating the hue in conformity with Hunter's color system.

The moisture permeability of the polarizer protective film is preferably 300 g/m²·24 hr or less, more preferably 250 g/m²·24 hr or less, still more preferably 200 g/m²·24 hr or less, particularly preferably 150 g/m²·24 hr or less, most preferably 100 g/m²·24 hr or less. When the moisture permeability of the polarizer protective film falls within such range, a polarizing plate excellent in durability and moisture resistance can be obtained.

The tensile strength of the polarizer protective film is preferably 10 MPa or more and less than 100 MPa, more preferably 30 MPa or more and less than 100 MPa. When the tensile strength is less than 10 MPa, the film may be unable to express a sufficient mechanical strength. When the tensile strength is more than 100 MPa, the processability of the film may be insufficient. The tensile strength may be measured in conformity with, for example, ASTM-D-882-61T.

The tensile elongation of the polarizer protective film is preferably 1.0% or more, more preferably 3.0% or more, still more preferably 5.0% or more. An upper limit for the tensile elongation is, for example, 100%. When the tensile elongation is less than 1%, the toughness of the film may be insufficient. The tensile elongation may be measured in conformity with, for example, ASTM-D-882-61T.

The tensile modulus of elasticity of the polarizer protective film is preferably 0.5 GPa or more, more preferably 1 GPa or more, still more preferably 2 GPa or more. An upper limit for the tensile modulus of elasticity is, for example, 20 GPa. When the tensile modulus of elasticity is less than 0.5 GPa, the film may be unable to express a sufficient mechanical strength. The tensile modulus of elasticity may be measured in conformity with, for example, ASTM-D-882-61T.

The polarizer protective film may contain any appropriate additive in accordance with purposes. Specific examples of the additive include: UV absorbers; antioxidants, such as hindered phenol-based, phosphorus-based, and sulfur-based antioxidants; stabilizers, such as a light stabilizer, a weathering stabilizer, and a heat stabilizer; reinforcing materials, such as glass fiber and carbon fiber; near-infrared absorbers; flame retardants, such as tris(dibromopropyl) phosphate, triallyl phosphate, and antimony oxide; antistatic agents, such as anionic, cationic, and nonionic surfactants; coloring agents, such as an inorganic pigment, an organic pigment, and a dye; organic fillers and inorganic fillers; resin modifiers; organic filling agents and inorganic filling agents; plasticizers; and lubricants. The additive may be added at the time of the polymerization of the acrylic resin, or may be added at the time of the formation of the film. The kinds, number, combination, addition amounts, and the like of the additives may be appropriately set in accordance with purposes.

An easy-adhesion layer may be formed on one surface of the polarizer protective film. The easy-adhesion layer contains, for example, aqueous polyurethane and an oxazoline-based cross-linking agent.

### E. Polarizing Plate

The polarizer protective film of the present invention described in the section A to the section D is applicable to a polarizing plate. Therefore, the present invention also includes a polarizing plate using such polarizer protective film. The polarizing plate typically includes a polarizer and the polarizer protective film of the present invention arranged on at least one side of the polarizer. The polarizer protective film of the present invention may be arranged on each of both sides of the polarizer, or may be arranged on one side of the polarizer. When the polarizer protective film of the present invention is arranged on one side of the polarizer, any appropriate polarizer protective film may be arranged on the other side thereof, or the polarizer protective film may not be arranged.

Any appropriate polarizer may be adopted as the polarizer. For example, a resin film forming the polarizer may be a single-layer resin film, or may be a laminate of two or more layers.

Specific examples of the polarizer including a single-layer resin film include: a polarizer obtained by subjecting a hydrophilic polymer film, such as a polyvinyl alcohol (PVA)-based film, a partially formalized PVA-based film, or an ethylene-vinyl acetate copolymer-based partially saponified film, to dyeing treatment with a dichroic substance, such as iodine or a dichroic dye, and stretching treatment; and a polyene-based oriented film, such as a dehydration-treated product of PVA or a dehydrochlorination-treated product of polyvinyl chloride. A polarizer obtained by dyeing the PVA-based film with iodine and uniaxially stretching the resultant is preferably used because the polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching has been performed. The PVA-based film is subjected to swelling treatment, cross-linking treatment, washing treatment, drying treatment, or the like as required. For example, when the PVA-based film is immersed in water to be washed with water before the dyeing, contamination or an antiblocking agent on the surface of the PVA-based film can be washed off. In addition, the PVA-based film is swollen and hence dyeing unevenness or the like can be prevented.

The polarizer obtained by using the laminate is specifically, for example, a polarizer obtained by using a laminate of a resin substrate and a PVA-based resin layer (PVA-based resin film) laminated on the resin substrate, or a laminate of a resin substrate and a PVA-based resin layer formed on the resin substrate through application. The polarizer obtained by using the laminate of the resin substrate and the PVA-based resin layer formed on the resin substrate through application may be produced by, for example, a method involving: applying a PVA-based resin solution to the resin substrate; drying the solution to form the PVA-based resin layer on the resin substrate, thereby providing the laminate of the resin substrate and the PVA-based resin layer; and stretching and dyeing the laminate to turn the PVA-based resin layer into the polarizer. In this embodiment, the stretching typically includes the stretching of the laminate under a state in which the laminate is immersed in an aqueous solution of boric acid. The stretching may further include the in-air stretching of the laminate at high temperature (e.g., 95° C. or more) before the stretching in the aqueous solution of boric acid as required. The resultant laminate of the resin substrate and the polarizer may be used as it is (i.e., the resin substrate may be used as a protective layer for the polarizer). Alternatively, a product obtained as described below may be used: the resin substrate is peeled from the laminate of the resin substrate and the polarizer, and any appropriate protective layer in accordance with purposes is laminated on the peeled surface. Details of such method of producing a polarizer are described in, for example, Japanese Patent Application Laid-open No. 2012-73580. The entire description of the publication is incorporated herein by reference.

The thickness of the polarizer is, for example, from 1 μm to 80 μm. In one embodiment, the thickness of the polarizer is preferably from 1 μm to 20 μm, more preferably from 3 μm to 15 μm.

### F. Image Display Apparatus

The polarizing plate described in the section E is applicable to an image display apparatus. Therefore, the present invention also includes an image display apparatus using such polarizing plate. Typical examples of the image display apparatus include a liquid crystal display apparatus and an organic electroluminescence (EL) display apparatus. Detailed description of the image display apparatus is omitted because a configuration well known in the art is adopted.

The present invention is specifically described below by way of Examples. However, the present invention is not limited by these Examples. Methods of measuring respective characteristics are as described below. In Examples, “part(s)” and “%” are by weight unless otherwise stated.

### (1) Length-to-Thickness Ratio of Reinforcing Particles

A section of each of polarizer protective films obtained in Examples and Comparative Examples was photographed with a transmission electron microscope (e.g., an acceleration voltage of 80 kV, a RuO₄ staining ultrathin sectioning method), and the 30 longest particles were sampled from reinforcing particles present in the resultant photograph. The average of the lengths of the 30 sampled particles and the average of the thicknesses thereof were each calculated, and the ratio of the average of the lengths to the average of the thicknesses was determined.

### (2) Bending Resistance Test

Each of the polarizer protective films obtained in Examples and Comparative Examples was cut into a size measuring 15 mm wide by 120 mm long to provide a measurement sample. The number of times of bending until the measurement sample ruptured was measured with an MIT testing machine under the conditions of a load of 200 g, a swing angle of 135°, and a swing speed of 175 times/min.

(3) Adhesive Strength with Polarizer

An adhesive strength between a polarizer protective film and a polarizer was evaluated by subjecting each of polarizing plates obtained in Examples and Comparative Examples to a peel test. Specifically, the evaluation was performed as follows. The polarizing plate was cut out into a size measuring 200 mm in the absorption axis direction of the polarizer by 15 mm in the direction perpendicular to the absorption axis. A notch was made in a space between the protective film and the polarizer with a box cutter, and the resultant was bonded to a glass plate. The protective film and the polarizer were peeled from each other with Tensilon in a 90° direction at a peel rate of 300 mm/min, and an initial peel strength (N/15 mm) therebetween was measured.

### Example 1

### (Production of Polarizer Protective Film)

An MS resin (MS-200; a copolymer containing methyl methacrylate and styrene at a molar ratio “methyl methacrylate/styrene” of 80/20, manufactured by Nippon Steel Chemical Co., Ltd.) was imidized with monomethylamine (imidization ratio: 5%). The resultant imidized MS resin had a glutarimide unit represented by the general formula (1) (R² and R³ each represented a methyl group, and R² represented a hydrogen atom), a (meth)acrylic acid ester unit represented by the general formula (2) (R⁴ and R⁵ each represented a methyl group), and a styrene unit. An intermeshed co-rotation biaxial extruder having a caliber of 15 mm was used in the imidization. The temperature of each temperature control zone of the extruder was set to 230° C. and the number of revolutions of the screw thereof was set to 150 rpm. The MS resin was supplied at 2.0 kg/hr, and the supply amount of monomethylamine was set to 2 parts by weight with respect to 100 parts by weight of the MS resin. The MS resin was loaded from a hopper, and the resin was melted and filled in a kneading block, followed by the injection of monomethylamine from a nozzle. The resin was filled in the terminal of a reaction zone by inserting a seal ring. A by-product and excess methylamine after the reaction were devolatilized by reducing a pressure at a vent port to −0.08 MPa. The resin discharged as a strand from a die arranged at the outlet of the extruder was cooled in a water bath, and was then pelletized with a pelletizer. The resultant imidized MS resin had an imidization ratio of 5.0% and an acid value of 0.5 mmol/g. Its Tg was 120° C.

90 Parts by weight of the imidized MS resin obtained in the foregoing and 10 parts by weight of core-shell-type particles (manufactured by Kaneka Corporation, product name: “KANE ACE M-210”) were loaded into a uniaxial extruder, and were melted and extruded at 260° C. to provide a film having a thickness of 120 μm. The resultant extruded film was subjected to simultaneous biaxial stretching at a stretching temperature of 160° C. in its lengthwise direction and widthwise direction to twice each. A stretching speed in each of the lengthwise direction and the widthwise direction was 10%/sec. The core-shell-type particles were flattened by the stretching, and hence reinforcing particles were formed. The length-to-thickness ratio of the reinforcing particles was 6.3. Thus, a polarizer protective film was produced. The resultant polarizer protective film had a thickness of 40 μm, an in-plane retardation Re(550) of 2 nm, and a thickness direction retardation Rth(550) of 2 nm. The resultant polarizer protective film was subjected to the evaluation (2). The result is shown in Table 1.

### (Production of Polarizing Plate)

### 1. Production of Polarizer

While an elongated roll of a polyvinyl alcohol (PVA)-based resin film having a thickness of 30 μm (manufactured by Kuraray Co., Ltd., product name: “PE3000”) was subjected to uniaxial stretching with a roll stretching machine in its lengthwise direction so that a stretching ratio in the lengthwise direction became 5.9 times, at the same time, the roll was subjected to swelling, dyeing, cross-linking, and washing treatments. Finally, the roll was subjected to drying treatment to produce a polarizer having a thickness of 12 μm.

Specifically, in the swelling treatment, the roll was stretched to 2.2 times while being treated in pure water at 20° C. Next, in the dyeing treatment, the roll was stretched to 1.4 times while being treated in an aqueous solution at 30° C. containing iodine and potassium iodide at a weight ratio of 1:7 in which an iodine concentration was adjusted so that the single layer transmittance of the polarizer to be obtained became 45.0%. Further, two-stage cross-linking treatment was adopted in the cross-linking treatment. In first-stage cross-linking treatment, the roll was stretched to 1.2 times while being treated in an aqueous solution at 40° C. having dissolved therein boric acid and potassium iodide. The boric acid content of the aqueous solution in the first-stage cross-linking treatment was set to 5.0 wt %, and the potassium iodide content thereof was set to 3.0 wt %. In second-stage cross-linking treatment, the roll was stretched to 1.6 times while being treated in an aqueous solution at 65° C. having dissolved therein boric acid and potassium iodide. The boric acid content of the aqueous solution in the second-stage cross-linking treatment was set to 4.3 wt %, and the potassium iodide content thereof was set to 5.0 wt %. In addition, in the washing treatment, the roll was treated in an aqueous solution of potassium iodide at 20° C. The potassium iodide content of the aqueous solution in the washing treatment was set to 2.6 wt %. Finally, in the drying treatment, the roll was dried at 70° C. for 5 minutes to provide the polarizer.

### 2. Production of Polarizing Plate

An easy-adhesion layer (thickness: 350 nm) containing aqueous polyurethane and an oxazoline-based cross-linking agent was famed on one surface of the polarizer protective film obtained in the foregoing. The easy-adhesion layer of the polarizer protective film was bonded to one side of the above-mentioned polarizer through intermediation of a polyvinyl alcohol-based adhesive. Thus, a polarizing plate was obtained. The resultant polarizing plate was subjected to the evaluation (3). The result is shown in Table 1.

### Example 2

A polarizer protective film and a polarizing plate were each produced in the same manner as in Example 1 except that: the compounding amount of the core-shell-type particles was set to 15 parts by weight; and the length-to-thickness ratio of the reinforcing particles was set to 5.4 by adjusting the stretching conditions. The polarizer protective film and the polarizing plate were each subjected to the same evaluation as that of Example 1. The results are shown in Table 1.

### Example 3

A polarizer protective film and a polarizing plate were each produced in the same manner as in Example 1 except that: the compounding amount of the core-shell-type particles was set to 25 parts by weight; and the length-to-thickness ratio of the reinforcing particles was set to 5.0 by adjusting the stretching conditions. The polarizer protective film and the polarizing plate were each subjected to the same evaluation as that of Example 1. The results are shown in Table 1.

### Comparative Example 1

A polarizer protective film and a polarizing plate were each produced in the same manner as in Example 1 except that: the compounding amount of the core-shell-type particles was set to 5 parts by weight; and the length-to-thickness ratio of the reinforcing particles was set to 5.2 by adjusting the stretching conditions. The polarizer protective film and the polarizing plate were each subjected to the same evaluation as that of Example 1. The results are shown in Table 1.

### Comparative Example 2

A polarizer protective film and a polarizing plate were each produced in the same manner as in Example 1 except that the length-to-thickness ratio of the reinforcing particles was set to 8.4 by adjusting the stretching conditions. The polarizer protective film and the polarizing plate were each subjected to the same evaluation as that of Example 1. The results are shown in Table 1.

### Comparative Example 3

A polarizer protective film and a polarizing plate were each produced in the same manner as in Example 2 except that the length-to-thickness ratio of the reinforcing particles was set to 8.2 by adjusting the stretching conditions. The polarizer protective film and the polarizing plate were each subjected to the same evaluation as that of Example 1. The results are shown in Table 1.

### Comparative Example 4

A polarizer protective film and a polarizing plate were each produced in the same manner as in Example 3 except that the length-to-thickness ratio of the reinforcing particles was set to 8.8 by adjusting the stretching conditions. The polarizer protective film and the polarizing plate were each subjected to the same evaluation as that of Example 1. The results are shown in Table 1.

TABLE 1

| | | | Bending | |
|---|---|---|---|---|
| | | | resistance | |
| | | | (number | Adhesiveness |
| | Compounding | Length-to- | of times of | with |
| | amount of | thickness | bending | polarizer |
| | reinforcing | ratio of | until | (initial |
| | particles | reinforcing | rupture | peel |
| | (part(s)) | particles | occurs) | strength) |
| Example 1 | 10 | 6.3 | 586 | 1.8 |
| Example 2 | 15 | 5.4 | 707 | 1.7 |
| Example 3 | 25 | 5.0 | 1,019 | 1.1 |
| Comparative | 5 | 5.2 | 181 | 1.9 |
| Example 1 | | | | |
| Comparative | 10 | 8.4 | 738 | 0.9 |
| Example 2 | | | | |
| Comparative | 15 | 8.2 | 884 | 0.9 |
| Example 3 | | | | |
| Comparative | 25 | 8.8 | 1,418 | 0.5 |
| Example 4 | | | | |

### <Evaluation>

As is apparent from Table 1, the polarizer protective films of Examples of the present invention are each excellent in bending resistance and adhesiveness with the polarizer in a balanced manner. When the length-to-thickness ratio of the reinforcing particles deviates from the range of the present invention, the adhesiveness with the polarizer significantly reduces. In addition, it is found that the bending resistance is significantly improved by adjusting the content of the reinforcing particles.

The polarizer protective film of the present invention is suitably used in a polarizing plate. The polarizing plate of the present invention is suitably used in an image display apparatus. The image display apparatus of the present invention can be used for various applications, such as portable devices including a personal digital assistant (PDA), a smartphone, a cellular phone, a clock and a watch, a digital camera, and a portable gaming machine, OA devices including a personal computer monitor, a notebook-type personal computer, and a copying machine, household electric appliances including a video camera, a television set, and a microwave oven, on-board devices including a reverse monitor, a monitor for a car navigation system, and a car audio, exhibition devices including digital signage, an information monitor for a commercial store, security devices including a surveillance monitor, and caring/medical devices including a caring monitor and a medical monitor.

Many other modifications will be apparent to and be readily practiced by those skilled in the art without departing from the scope and spirit of the invention. It should therefore be understood that the scope of the appended claims is not intended to be limited by the details of the description but should rather be broadly construed.

1. A polarizer protective film, comprising:
an acrylic resin; and
reinforcing particles dispersed in the acrylic resin,
wherein the reinforcing particles have flat shapes, and have a length-to-thickness ratio of 7.0 or less.

2. The polarizer protective film according to claim 1, wherein the acrylic resin has at least one selected from the group consisting of a glutarimide unit, a lactone ring unit, a maleic anhydride unit, a maleimide unit, and a glutaric anhydride unit.

3. The polarizer protective film according to claim 1, wherein a content of the reinforcing particles is from 7 wt % to 30 wt %.

4. The polarizer protective film according to claim 1, wherein the length-to-thickness ratio of the reinforcing particles is 2.0 or more.

5. The polarizer protective film according to claim 1, wherein the reinforcing particles each have a core formed of a rubber-like polymer and a covering layer formed of a glass-like polymer, the covering layer being configured to cover the core.

6. The polarizer protective film according to claim 5, wherein the core has a thickness of from 20 nm to 100 nm, and the core has a characteristic length of from 200 nm to 600 nm.

7. The polarizer protective film according to claim 1, wherein the polarizer protective film comprises a biaxially stretched film.

8. The polarizer protective film according to claim 1, wherein the polarizer protective film has an in-plane retardation Re(550) of from 0 nm to 10 nm, and has a thickness direction retardation Rth(550) of from −20 nm to +10 nm.

9. (canceled)

10. (canceled)

11. A polarizer protective film, comprising:
an acrylic resin; and
reinforcing particles dispersed in the acrylic resin,
wherein the acrylic resin has at least one selected from the group consisting of a glutarimide unit, a lactone ring unit, a maleic anhydride unit, a maleimide unit, and a glutaric anhydride unit,
wherein the reinforcing particles each have a core formed of a rubber-like polymer and a covering layer formed of a glass-like polymer, the covering layer being configured to cover the core,
wherein the reinforcing particles have flat shapes, and have a length-to-thickness ratio of 2.0 to 7.0, and
wherein a content of the reinforcing particles is from 7 wt % to 30 wt %.

12. The polarizer protective film according to claim 11, wherein the polarizer protective film has an in-plane retardation Re(550) of from 0 nm to 10 nm, and has a thickness direction retardation Rth(550) of from −20 nm to +10 nm.

13. A polarizing plate, comprising:
a polarizer; and
the polarizer protective film of claim 1 arranged on at least one side of the polarizer.

14. A polarizing plate, comprising:
a polarizer; and
the polarizer protective film of claim 11 arranged on at least one side of the polarizer.

15. An image display apparatus, comprising the polarizing plate of claim 13.

16. An image display apparatus, comprising the polarizing plate of claim 14.
